(19) United States
(12) Patent Application Publication
(10) Pub. No.: US 2008/0146254 A1
(43) Pub. Date: Jun. 19, 2008

(54) Process For Generating, Sending and Receiving Mms-Messages, a Computer Program and a Machine Readable Memory Media

(76) Inventor: Martin E. Groeger, Berlin (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/596,146

(22) PCT Filed: Dec. 2, 2004
(86) PCT No.: PCT/EP04/13863

§ 371 Date: Feb. 1, 2008

(30) Foreign Application Priority Data
Dec. 2, 2003 (DE) 103 57 417.4
Mar. 25, 2004 (DE) 10 2004 015 944.0

(51) Int. Cl. H04Q 7/20

(52) U.S. Cl. 455/466

(57) ABSTRACT

The invention relates to a method for the generation, sending and receiving of MMS messages and the computer programme product, for the generation, sending and receiving of MMS messages which permit the sending and receiving of MMS messages from PC to PC, from PC to mobile terminal and mobile terminal to PC and to playback, record and generate the same on a PC.

### DESCRIPTION

The invention relates to a process for generating, sending and receiving MMS-Messages, a computer program and a machine readable memory media with the attributes written out in the upper term of claims 1, 22 and 24.

It is known, that mobile telephones next to the pure transfer of voice are offering a several other services. The short message service (SMS) for instance is a telecommunication service for the transfer of short text messages. Even though SMS is describing the service for short messages, today SMS is used as an abbreviation for the message itself. Originally developed only for the use with mobile phones, today most of the digital fixed telephone networks are supporting the sending and receiving of SMS as well.

Further, based on the mobile Internet, the Multimedia Messaging Service (MMS) is known allowing the sending of multimedia Messages from one to an other mobile device. The MM (Multimedia Message) can contain a multiple of files of different types. It is therefore possible to send simple text, pictures, music, animations and even short video sequences to one or more recipients. MMS is not compatible to SMS, End user devices, Network infrastructure and applications must be capable of supporting the MMS-Standard. Technically MMS is relating in many areas to already existing standards from WWW-Consortium (W3C), the 3^{rd} Generation Partnership Project 2 (3GPP2), and the Open Mobile Alliance (OMA). Similar to a slideshow by using MMS, Picture sequences containing pictures, sound and text of different length can be combined in that way, that the viewer of such message in only one frame can see multimedia similar to an thumb-cinema or an short film.

With the mobile device MMS-Messages can not only be send to MMS enabled mobile phones but also to E-Mail addresses. Traditional E-Mail Programs however are not supporting the MMS Fromat. Therefore an packed MMS-file with the file extension *.mms can not be unpacked and opened for viewing in an viewing frame as recommended by the standardization committee by traditional E-Mail Programs such as Microsoft Outlook. Also the description languages and formats used by the MMS-Standard are partly not supported by traditional E-Mail Programs. As example listed here SMIL (Synchronized Multimedia Integration Language) or the sound format AMR (Adaptive Multirate) *.amr under the specification from ETSI (European Telecommunication Standards Institute) 1999. The Synchronized Multimedia Integration Language is an XML based, from the World Wide Web Consortium (W3C) developed standard for an markup-language for time synchronized, multimedia content. SMIL enabling for example the integration and control of multimedia-elements such as audio, video, text and graphic in websites.

With the sending of MMS-Messages from mobile-phones to E-Mail addresses using the infrastructure of network operators specific MMS-formats such as SMIL or AMR will be filtered out and such formats will not be delivered and forwarded to the particular E-Mail address because existing E-Mail Programs can not process such formats. As a result an MMS-Message contains only the formats processed by conventional E-Mail Programs such as text or pictures or sound attached to the E-Mail as an extension. Such file-extensions must be opened and viewed by the user one by one. Hence the essential feature to view integrated multimedia content of different types which the XML-dialect SMIL allows will not be used. Finally because of the before mentioned reasons conventional E-Mail Programs or Computer Programs are not allowing the PC-based generation of MMS-files.

At the same time web based MMS-Applications are known. Disadvantageous of such applications is that the generation, storage, process and playing of MMS Messages can only be performed when online or Internet access is given. An “offline-usage” of the MMS-based Message exchange with the own PC therefore is not possible. Similar with the use of E-Mail Programs the opportunity of receiving, storing, processing and sending of MMS-Messages locally with an PC is not given. Because of this reason web based MMS-Programs do not allow the sending of MMS-Messages to E-Mail addresses.

It is therefore task of the existing invention to state an process, an computer program and an machine readable memory media allowing the generation, the sending and the receiving of MMS-Messages with an PC installed program between different PCs, from one PC to MMS-enabled mobile phones and from mobile phones to an computer.

This task is solved by the invention through the attributes of the characterizing part of the claim 1 as well as the claims 22 and 24 in combination with the attributes of the upper term. Suitable statements of the invention are included in the lower attributes.

The invention of the process for generating, sending and receiving of MMS-Messages is therefore being marked, that the process is client based and will be realised on a data processing equipment.

In particular it is of advantage that the inventing process, in opposite to the current technology used for generating, processing and playing of MMS-Messages is allowing the use of data processing equipment off-line, means without an internet access. This allows reducing of cost and to use the existing memory devices of the data processing equipment for the receiving and sending of MMS. Only for the sending and receiving an internet connection is being used.

The sending and receiving of MMS-Messages typically is being performed between at least on data processing equipment to at least on other data processing equipment respectively between at least one mobile phone device and at least one data processing equipment.

The generating of MMS-Messages on a data processing equipment is combining at least one of the following processing steps for at least one frame: Loading and fitting together of pictures as part of an bitmap into an empty bitmap at the beginning; the adding of music by creating an music file; the adding of text by creating an text file; the definition of the playing time of the frame; the combining of several single frame bitmaps to one single bitmap; the storing of such bitmap together with the music file and text file in an working class; the creating of an SMIL file out of the working class files; as well as the combining of all files in the working class into an MMS file. The loading of picture- and music files is performed through drag & drop. The picture- and music files are available in the local file system or they will be loaded from the internet.

To play an MMS file the file typically will be taken apart in that way that the SMIL file and for each of the frames at least one file of the category picture, music or text is being created. The created picture- and text files depending there corresponding playing time will be displayed and together with the sound file played.

Typically the sending of MMS-Messages including the following steps: The generation of an Mail from type “multipart/related” taking the MMS file by using a coding process and the sending of such Mail by using the interfaces and the SMTP-Protocol to an mail server. For the receipt interfaces of E-Mail-Protocols is being utilized, in such a way that the receiving mail after decoding an MMS file is generated. The interfaces to send and receive are typically TCP/IP Sockets, the E-Mail protocol to receive is realized by the POP3-Protocol.

It is advantageous that the process consisting out of the following features. The administration of archives “INBOX” and “OUTBOX”, the administration of an account with account information and details for registration under “INFO” and “OPTIONS”, the administration of payment/credits under “DEPOT” the receiving of MMS under “RECEIVE”, the sending of MMS under “SEND”, the playing of MMS with “PLAY”, the composing and configuration of new MMS, in that way that overlaying, moving, scaling of pictures, the editing of pictures in frames is possible as well as inserting bibliotheca of MMS shaping elements consisting out of Text-, Sound- and graphical patterns for the generation of MMS-Messages, the combining of sequences with an simple timing, the combination consisting out of Pictures/Sound/Text information per frame, the generation and administration of picture archives with conversion into the MMS format “IMAGES”, the generation and administration of sound archives with conversion into the MMS format “SOUND”, the generation and administration of addresses “ADDRESS”, the administration of Program surfaces under “INFO” and “SKIN”.

Further it is of advantage that the process for sending of MMS-Messages from one computer, which is being marked in that way, that the sending is being charged. The process is combining the following steps: The registration of a user in a internet portal. The sending of an password and user name from the portal to the user; and the purchase of credits through the user for the sending of MMS Messages. The purchased credits will be credited on a computer and displayed in that way, that a server for authentification of the mail-mark and reading of credit information will be addressed.

An Computer program is stated, that will enable an data processing equipment, after being loaded into the memory of the data processing equipment, to realize a process for generating, sending and receiving of MMS-Messages according to the process of the invention.

Further an computer readable memory media will be stated, which is suitable to be read by an reading device connected to an data processing equipment, characterized by the content of the memorized program, which is suitable to be loaded into the processing unit of the data processing equipment to carry out the process of the invention.

The invention will be explained further according to the examples. It is showing:

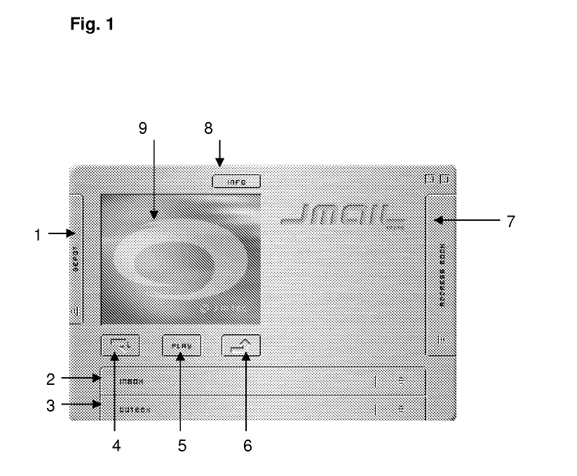

FIG. 1: The user interface of the Computer program with the functions “Depot”, “Inbox”, “Outbox” and “Address book” for an first example.

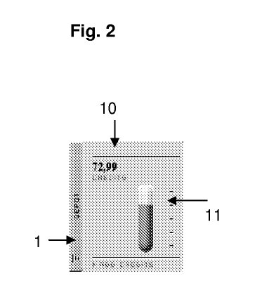

FIG. 2: The graphical user interface with the functions “Depot” of the invention computer program with credit status for an first example.

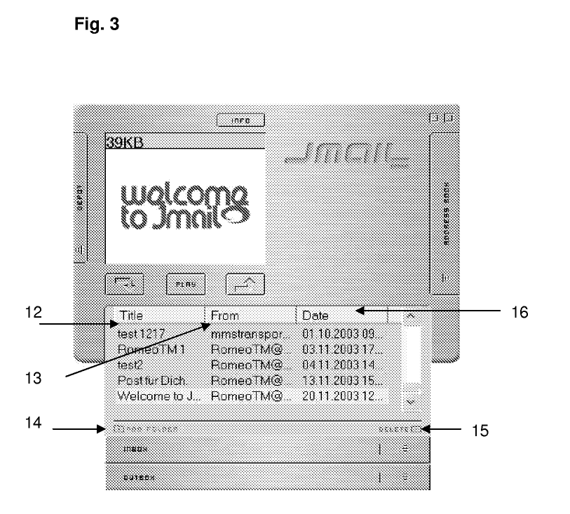

FIG. 3: The graphical user interface with the functions “Inbox” and “Play” of the invention computer program for an first example.

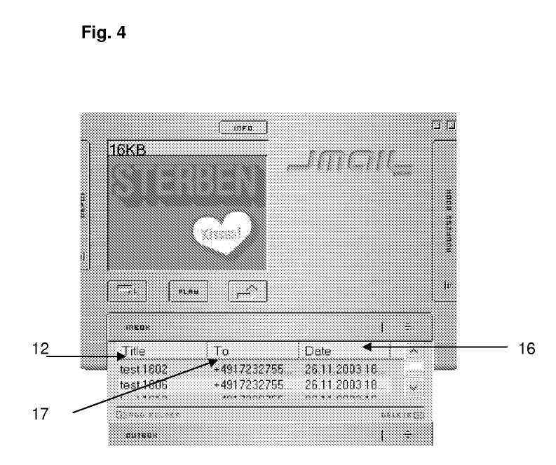

FIG. 4: The graphical user interface with the functions “Outbox” of the invention computer program for an first example.

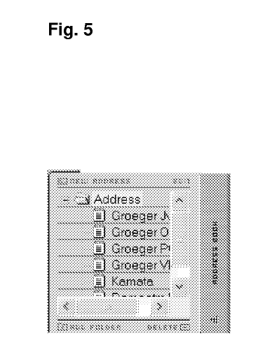

FIG. 5: The graphical user interface with the functions “Address book” of the invention computer program for an first example.

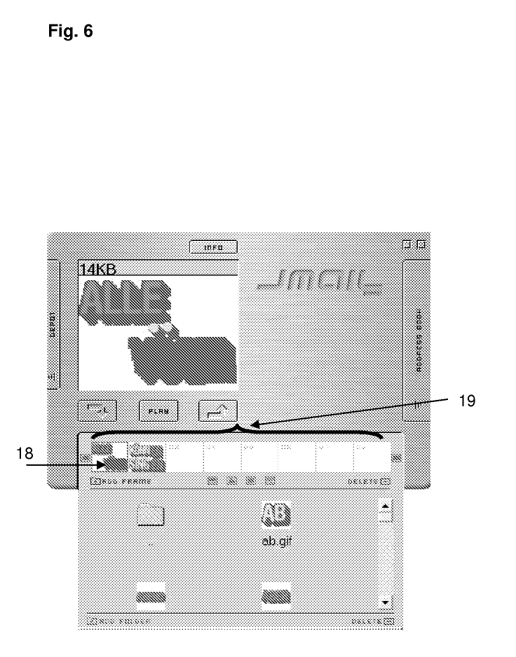

FIG. 6: The graphical user interface with the functions “Composing” of the invention computer program for an first example.

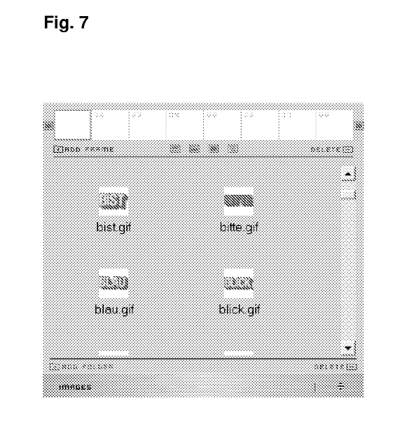

FIG. 7: The graphical user interface with the functions “Poetry” of the invention computer program for an first example.

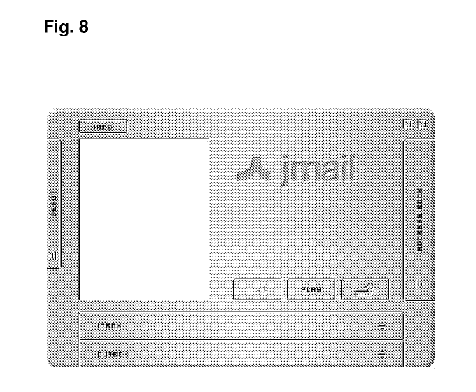

FIG. 8: The user interface of the invention computer program with it's functions “Depot”, “Inbox”, “Outbox”, “Address book” for an second example.

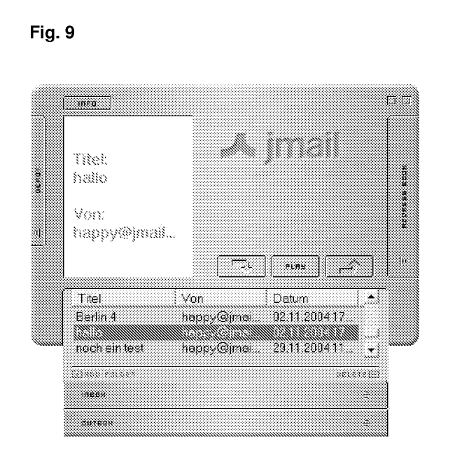

FIG. 9: The graphical user interface of the function “Inbox” and “Play” of the invention computer program for an second example.

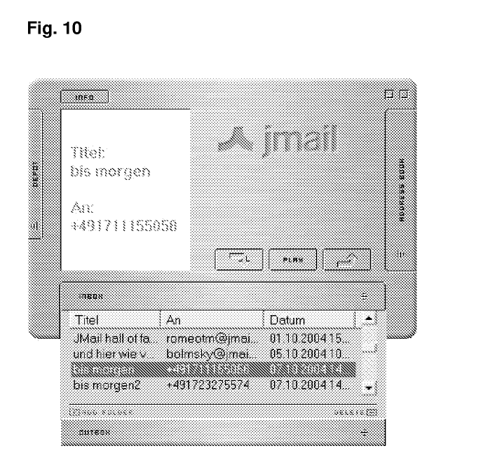

FIG. 10: The graphical user interface of the function “Outbox” of the invention computer program for an second example.

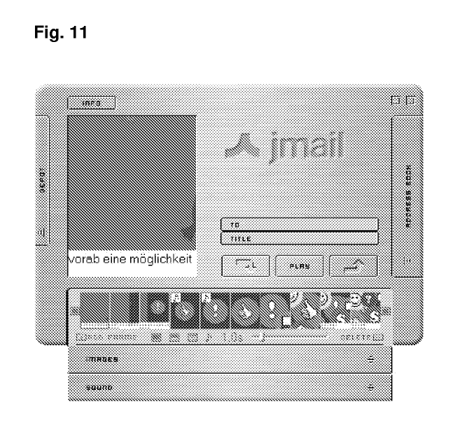

FIG. 11: The graphical user interface of the function “Composing” of the invention computer program for an second example.

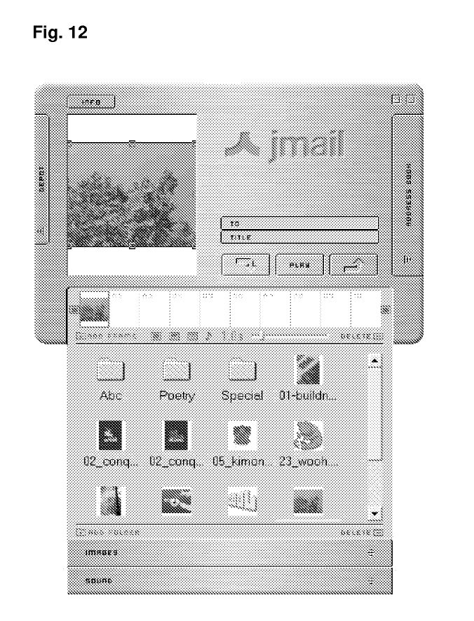

FIG. 12: The graphical user interface of the function “Images/Sound” of the invention computer program for an second example.

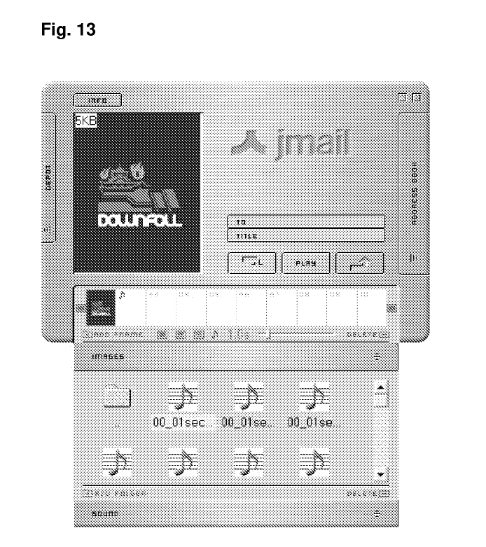

FIG. 13: The graphical user interface of the function “Sound” of the invention computer program for an second example.

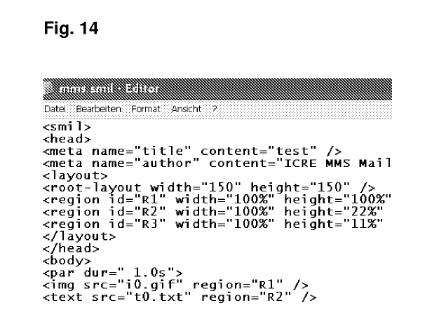

FIG. 14: Part of the invention generated SMIL file

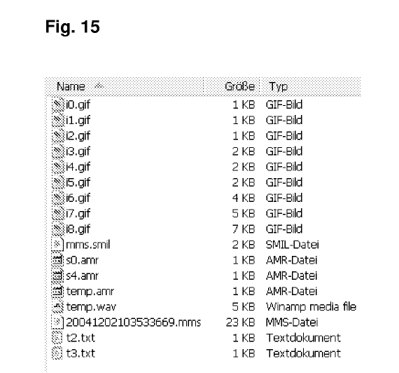

FIG. 15: Part of the invention MMS working class for composing of MMS-Messages.

With the invention process for generating, sending, receiving and playing of MMS Messages and the related computer program, called JMail-MMS, user can, similar like using a E-Mail program, act with the own PC and use the existing Infrastructure such as local memory and internet access, to create, send and receive MMS-Messages. Available MMS-Services in the market are web based and can not offer the functions which can be obtained with JMail-MMS. Those newly developed areas are marked by the program-functions, the way of realizing the design and GUI and the communication interfaces between program and server.

The PC-Program enables the user the creation of words, sentences, expressions combined with graphics, pictures, sounds, animations as well as voice messages and video sequences too, in order to send them as an MMS-file to one or multiple owner of mobile telephones or exchange them from PC to PC or mobile telephone to PC and vice versa. On an given PC the client must be installed. Messages-, greeting cards or product brochures than, by using the user interface and different functions, selected through bottoms, from PC using the MMS-format being send and being received too, which commonly used PC-, or E-mail programs could not perform, because they do not obtain the necessary MMS-compatibility.

The process and the computer product for the first time is being carried out as an client program for PCs allowing the generation of MMS-Messages the sending as well as the receiving of messages in an MMS Format.

The process and the computer program as an client program for PCs is marked through several program features which will be stated as an example as follows. At the one hand is allows the administration of the archive “INBOX”, in that way that the “Inbox” holds all incoming MMS Messages. FIG. 1 is showing the graphical user interface of the invention computer program with the bottoms for the functions “Depot” 1, “Inbox” 2, “Outbox” 1, “Address book” 7, “Play” 5, “Up” 6 and “Down” 4, symbolized through an arrow as well as the Menu bottom “Info” 8. FIG. 3 showing the corresponding user interface fort he functions “Inbox” 2 and “Play” 5. After klicking the function “Inobx” 2 the contended incoming messages with information for Title 12, message size, sender address 13 and the corresponding date 16 will be shown. For playing the incoming MMS Message from the “Inbox” 2 the “play” bottom needs to be pushed. The MMS than will be played in the preview window 9.

There will be an account administration for money/credits for each user under the function “DEPOT” made available in combination with account information and registration information under function “INFO” and “OPTIONS”. FIG. 2 shows the graphical user interface of the invention computer program for the Menu point “Depot” 1. The Depot “Credits” 10, an internal currency, will be shown with the graphic-bar 11.

Further an additional function is the administration with the archive “OUTBOX”, in that respect, that the mentioned “Outbox” is holding all send out MMS Messages. FIG. 4 is showing the graphical user interface of the invention computer program with the function “Outbox” 3. After clicking the function “Outbox” 3 all stored already send out messages will be shown with information for Title 12, message size, target address 17 and the corresponding date 16. For playing of the send message from the “Outbox” “Play” 5 of the Menu point needs to be clicked. The MMS will than be played in the preview window 9.

The receipt of MMS by “RECEIVE” is an additional function, same as the sending of MMS with the function “SEND” and the play of MMS with “PLAY.

Addresses can be generated and administrated under “ADDRESS” same as graphical user interfaces under “INFO” and “SKIN”. FIG. 5 is showing the graphical user interface of the invention computer program for the function “Address book” 7. The Address book 7 allows to enter, edit and store addresses.

The client program is also allowing the composing and configuration of new MMS, in that way that overlay, scaling and moving of pictures as well as editing the pictures and frames is possible and bibliotheca of MMS-creating elements consisting out of Text-, Sound- and graphical patterns for the generation of MMS-Messages are being offered for integration. Frame-sequences with simple timing (0.1-45 seconds) can be combined and put together for each frame picture, Sound and text information. FIG. 6 is showing the graphical user interface of the invention computer program for the function “Compose”. The Function Compose for MMS-Messages at first opens up a composing window with and endless preview 19 for the single frames 18 and an preview window 9 of the user interface. Editing functions such as overlay, scaling, moving of pictures, Text input, selecting of layout, deleting and preview are given. Setting the time for the generation and frame frequency is given. Further the composing window is showing trays of Images and Sound. All such functions can be accessed on the basis of drag & drop with a mouse.

FIG. 7 is showing the graphical user interface of the invention computer program for the function “Poetry”. The invention computer program includes an excessive bibliotheca of letters, syllables and words as a graphic, around 500 pieces with one single font. The elements will be placed per drag & drop for the generation of sentences and messages.

Further picture archives can be generated and administrated by converting them at the same time into the MMS format “IMAGES”. The generation and administration of sound archives by converting them at the same time into the MMS format “SOUND” is also given.

FIG. 8 is showing the user interface of the invention computer program with the functions “Depot”, “Inbox”, Outbox” and “Address book” as an second example.

FIG. 9 is showing the graphical user interface of the function “Inbox” and “Play” of the invention computer program for an second example. The “Inbox” is showing the received MMS Messages with information for Title of the message, the sender and the date received. With the menu point “Play” the received message can be played in the preview window.

FIG. 10 is showing the graphical user interface for the function “Outbox” for the invention computer program as an second example. The “Outbox” is showing the already send MMS messages with the information for title of the message, the receiver and the date of the message. With the Menu function “Play” the send message can be played in the preview window of the user interface.

FIG. 11 is showing the graphical user interface for the function “compose” for the invention computer program as an second example. The compose function for MMS messages at first is opening an composing window with and endless preview for the single frames. A preview of the composed MMS is possible in the preview window. The editing function, adding of frames, selection of layout, option for adding and deleting of sound as well as the setting of seconds (from 0.1-45.0 seconds) and deleting of frames is given. For editing the following functions are being offered. Overlay, scaling, moving of pictures, text input, selection of layout, deleting and preview. Further the composing window showing trays for Images and Sounds. All that functions can be accessed by “drag and drop” with a mouse. The title and the receiver for the completed MMS can be entered.

FIG. 12 is showing the graphical user interface for the function “Images/Sound” of the invention computer program for an second example. The invention computer program contains several graphic bibliotheca. Different graphic formats such as jpeg, gif, bmp, tif, png can be used they will be automatically converted into the format for MMS-sending. Graphic files from an Internet source can be also included by drag & drop.

FIG. 13 showing the graphical user interface for the function “Sound” of the invention computer program for an second example. The invention computer program contains several sound bibliotheca. Different sound formats such as wav and amr can be used, they will be automatically converted into the format for MMS-sending. Sound files from an internet source can be also included by drag & drop.

The structure of the invention computer program can be separated into three areas. First the bibliotheca for taking apart and for composing of MMS (LIB-A) with access functions for all the components and incremental composing functions for picture/sound/text and converting functions for the different formats for single elements and whole MMS. Secondly the bibliotheca for the sending and receiving of MMS (LIB-B) with transactions with the MMS-Server, secure Data transfer, error treatment, logging as well as billing. Thirdly the JMail-Client-Application (APPL) with System source operations (files, classes, selections) MMS-operations A (portrayal/play, taking apart), MMS-Operations B (receiving, sending, forwarding), MMS-Operations C (composing), overlay, moving and scaling of pictures, putting together of sequences with an simple setting of time, putting together of Picture/sound/tex information per frame, MMS composing templates Text-, Sound- and decoration elements, account administration, administration of addresses, SKIN-Interface, and the main program.

An user A possesses a PC with an E-Mail program installed. In order to send/receive MMS-Messages from such PC and to send them to mobile phones, the user is installing the JMail-MMS program on such PC because otherwise the user can not send/receive MMS-formats. User A registers himself in the JMail-MMS Portal, obtains a password an user-name and immediately can receive MMS-Messages with his PC by using the JMail-MMS program. Now user A would also like send MMS-Messages.

Therefore he is buying “Credits” in the JMail-MMS Portal and after crediting the amount to his account he can see the balance under “DEPOT” of the program. Now he can generate MMS-Messages with his PC and send them to MMS-mobile phones and also receive them on his PC. Now user A can utilize his own PC for MMS, similar to what he is used when using his E-Mail program.

With PLAY he can play all newly incoming MMS-Messages immediately on his PC. With NEW he can generate MMS-Messages. He can use graphic-formats JPEG, GIV, PNG, TIFF, BNP Icon as well as WAVE sound formats and configure picture sequences with graphic, sound and text of any time. With PLAY under the compose modus he has the opportunity to preview the message and can edit the message by using the mouse and keyboard until he is satisfied with the result. For generating he is using the extensive bibliotheca “POETRY” und “ABC” in the IMAGES archive. Also the user is free to load per drag & drop files from his local computer drive or from any given internet source into the client user interface. He can show the inserted text with any offered graphics show and visualize it. With the result that for showing text no ASCII-signs are not necessary anymore in order to show text but the entered text will be automatically visualized in an graphical format. The options of the JMail-MMS program for user A for archiving and over viewing are offering sufficient usage comfort, in that way that all necessary functions for an MMS-communication are within the JMail-Program and the user do not need to change programs and/or web based offerings. Only for a short moment when sending/receiving the user is required to have internet access. Graphic files can be found under “IMAGES”, Sound files under “SOUND”, Addresses under “ADDRESS”, incoming and outgoing MMS-Messages under “INBOX” respectively “OUTBOX” and the credit information under “DEPOT”.

The main functions will be explained in the following now.

### Composing of MMS-Messages

The composition of an MMS Message will take place in the following way. An MMS-Message will be shown by the computer program by the portrayal of single pictures (frames) and will be packed into an archive file (MMS file) for sending which than will be send out. Reverse, when receiving an MMS file it will be taken apart into single frames. One frame will be generated by the following steps.

In a first step the empty bitmaps will be loaded with existing pictures as partial-bitmaps and put together. This loading happens on the surface through drag & drop, internally the chosen pictures which are available in an commonly used format (BMP/GIF/JPEG/PNG/TIFF) will be loaded into the preview area. The files can sit in the local file system or in an internet source. In the latter case the files, before loading, will be read via an TCP/IP-Socket-Interface (download). During the composing process the pictures can be edited this means scaled, enlarged and moved.

Than in an further step, a sound file will be added. In the same way this file will be loaded into the surface of the program by drag & drop, internally this file will be loaded as an AMR file converting it automatically from an WAF-format. This file too can be loaded from the local file system or from an internet source. Text will be added. Internally a file will be created, which contains the text. For each frame an playing time will be set (0.1-45.0 seconds).

Not all of the above mentioned steps are necessary but at least one of them.

When composing the MMS Message the bitmaps of each single frame out of the first step will be put together into a common bitmap creating one picture file. This file, together with the music file and text file will be stored in an working directory. After, following this method, all frames are being processed, a SMIL file is being created which will serve as and Index and will contain the size/position of the bitmaps as will as the playing time. Afterwards all generated files in the directory will be combined into an MMS file. FIG. 14 is showing a part of the invention creating a SMIL file.

FIG. 15 will show a part of the invention MMS directory for the composing of MMS Messages. In the relevant program library the MMS file, generated by the computer program, can be found with the extension *.mms, as will as the single items the music files with the extension *.wav and *.amr picture files for each frame with the extension *.gif, as well as text files with the extension *.txt and the generated SMIL-file with the extension *.smil.

Because of the fact that AMR file are consuming bigger memory capacity than wave files, the AMR files will be before sending converted into wave files. Therefore the invention computer program sending MMS Messages with optimized memory capacity.

### Taking Apart of MMS-Messages

The MMS file will be read and taken apart. The SMIL file will be created and for each single frame one picture file, one music file and one text file will be created but depending on the multimedia level of the message not necessarily all three but at leas one of the files will be created. When the composing modus is used, out of the given files for the frames depending on the information of the SMIL-file bitmaps will be created while creating for each single frame one bitmap.

### Playing the MMS-Message

For playing the MMS-Message the MMS file as described earlier will be taken apart, than the picture- and text files depending on the paying time displayed in the Play area together with the sound. The paying is also possible without composing.

### Sending of MMS-Messages

For sending out of the MMS-file there will be a “multipart/related” type Mail created, with the help of the coding process “base64” coded and than by use of TCP/IP-Sockets and the SMTP-Protocol send to the JMail-Server. Contrary to MIME-based Mails not an text file with attachments is being send but the MMS file as a whole. Preferable the MMS-file can be send as an attachment to the E-Mail, received and being used by the invention client program. The JMail-Server will also be used for authentification of the mail-code and for reading the credit-status (credit) which will be send/processed directly from the computer program.

### Receiving of MMS-Messages

For receiving TCP/IP (Sockets) and the POP3-Protocol will be used as well. From any source of the computer program, which has access to the mail-code, the MMS-Mail can be received. Therefore the Program differs from conventional Mail-Programs which sending Mail not as an MMS file but processing as MIME-format. From the received Mail after decoding from the base64-format the MMS-file will be generated.

The invention is not limited to the before mentioned examples. But it is possible by combination and modification of the mentioned methods and characteristics to realize additional examples without leaving the frame of the invention. Especially there is also a combination possible out of existing E-Mail-Programs in combination with the invention of the MMS-Client-Computer program possible.

### Bezugszeichenliste

1. Depot
2. Inbox
3. Outbox
4. Down
5. Play
6. Up
7. Address book
8. Info
9. Viewing window
10. Credits
11. Credit bar
12. Title
13. sender (“From”)
14. Adding of “Folders”
15. Delete
16. Date
17. receiver (“To”)
18. Frames
19. endless loop

1. Process for generating, sending and receiving of MMS-Messages, being marked in that way, that the process is client based realized on a data processing equipment.

2. Process following claim 1, being marked in that way, that the generation, composing and playing of MMS-Messages is realized offline on a data processing equipment.

3. Process following claim 1 or 2, being marked in that way, that only the sending and receiving of MMS-Messages is being realized online on a data processing equipment.

4. Process following at least one of the claims 1 to 3, being marked in that way, that the sending and receiving of MMS-Messages is realized between at least one first data processing equipment to at least an second data processing equipment.

5. Process following at least one of the claims 1 to 4, being marked in that way, that the sending and receiving from MMS-Messages is realized between at least one telecommunication device and at least one data processing equipment.

6. Process following at least one of the claims 1 to 5, being marked in that way, that the generation of MMS-Messages on an data processing equipment is covering at least one of the following process steps for at least one frame:
Loading and putting together of pictures as partial bitmaps in and at first empty bitmap;
Adding of music by creating a music file
Adding of text by creating a text file
setting of playing time of the frame
Putting together the single frame-bitmaps to one single combined bitmap.
Storing this bitmap together with the soundfile and the text file in an directory;
Creating of an SMIL-file from the files of the directory;
Combining of all files in the directory to one single MMS-file;

7. Process following claim 6, being marked in that way, that the loading of picture- and music files can be realized per drag & drop without intermediate storage.

8. Process following at least one of the claims 6 or 7, being marked in that way, that the picture and music files are available in the local storage system.

9. Process following at least one of the claims 6 or 7, being marked in that way, that the picture- and music files can be loaded from the internet per drag & drop directly into the program surface without intermediate storage.

10. Process following at least one of the claims 1 to 9, being marked in that way, that for playing of an MMS-file this will be taken apart, creating a SMIL-file and for each frame at least one file of the class picture, music or text.

11. Process following at least one of the claims 1 to 10, being marked in that way, that for playing of an MMS-Message the created picture- and text files will be played corresponding with the playing time set and together with the sound file played.

12. Process following at least one of the claims 1 to 11, being marked in that way, that the sending of MMS-Messages combining the following steps:
Creation of an Mail from type “multipart/related” form the MMS file by utilizing a coding process; and
Sending of the Mail by using interfaces and the SMTP-Protocol to an Mail server.

13. Process following at least one of the claims 1 to 12, being marked in that way, that for receiving interfaces and a E-Mail-Protocol are being utilized, in that way that after decoding a MMS-file will be created by taking the receive Mail.

14. Process following at least one of the claims 1 to 13, being marked in that way, that the interfaces for sending and receiving are TCP/IP sockets.

15. Process following at least one of the claims 1 to 13, being marked in that way, that the coding method for sending and receiving of MMS-Messages is realised through base64.

16. Process following claims 13, being marked in that way, that the E-Mail Protocol for receiving is realized through POP-3 Protocol.

17. Process following at least one of the claims 1 to 16, being marked in that way, that the process covers the following functions: The administration of archives “INBOX” and “OUTBOX”, the administration of an account with account information and registration information under “INFO” and “OPTIONS”, the administration of the account of money/credits under “DEPOT”, the receiving of MMS under “RECEIVE”, the sending of MMS under “SEND”, the playing of MMS with “PLAY”, the putting together and configuring of new MMS, in that way, that overlaying, moving and scaling of pictures, the editing of pictures and frames is possible as well as bibliotheca of MMS-composing-elements consisting out of text-, sound- and graphical templates for creating of MMS-Messages can be included, the putting together of sequences with simple time setting, the putting together of picture/sound/text information for each frame, the creation and administration of pictures archives with converting them at the same time into the necessary MMS format “IMAGES”, the generation and administration of sound archives with converting them at the same time into the necessary MMS format “SOUND”, the generation and administration of addresses “ADDRESS” , the administration of program surfaces under “INFO” and “SKIN”.

18. Process for sending of MMS-Messages from an computer, being marked in that way, that the sending is chargeable.

19. Process following claims 18, being marked in that way, that the process contains out of the following steps:
Registration of an user in an internet site
Sending of an password and username from the internet to the user.
Purchase of credits through the user in the internet site for the sending of MMS—Messages

20. Process following at least on of the claims 18 or 19, being marked in that way, that the value marks or Credits will be credited onto a computer and displayed accordingly.

21. Process following at least on of the claims 18 to 19, being marked in that way, that the Server for making the authentification of the mail-code and for reading the credit amount will be addressed.

22. Computer program that allows a data processing equipment after being loaded into the memory of the data processing equipment, to realize a process for generating, sending and receiving of MMS Messages following at least one of the claims 1 to 21 stated steps.

23. Process, which contains the steps of downloading a computer program according to the claim 22 by using electronic data-infrastructure, such as the internet onto a data processing equipment.

24. A computer readable storage media, which is suited to be read by a reading device connected to the data processing equipment, characterised by containing a stored program, which is suited to be loaded into the processing memory of a data processing equipment to implement the process following one of the claims 1 to 21.
